(19) United States
(12) Patent Application Publication
(10) Pub. No.: US 2011/0216190 A1
(43) Pub. Date: Sep. 8, 2011

(54) FOREIGN MATTER DETECTION DEVICE

(75) Inventors: Takayuki Shimazu, Yokohama-shi (JP); Hiroshi Suganuma, Yokohama-shi (JP); Yuji Kobayashi, Yokohama-shi (JP)

(73) Assignee: SUMITOMO ELECTRIC INDUSTRIES, LTD., Osaka-shi (JP)

(21) Appl. No.: 13/129,198

(22) PCT Filed: Nov. 4, 2009
(86) PCT No.: PCT/JP2009/068786

§ 371 Date: May 13, 2011

(30) Foreign Application Priority Data
Nov. 13, 2008 (JP) 2008-291288

(51) Int. Cl. H04N 7/18

(52) U.S. Cl. 348/135; 348/E07.085

(57) ABSTRACT

A foreign matter inspection apparatus, which enables more sufficient detection of foreign matter included in inspection objects, comprises: (1) a transparent drum having a cylindrical shape turning around a horizontal central axis; (2) an object supplying unit for supplying inspection objects to such a given region on the surface of the drum as will not cause the inspection objects to slide; (3) a first image capturing unit for imaging the inspection objects placed on a first imaging area included in the given region, such imaging being done from outside the drum; (4) a second image capturing unit for imaging the inspection objects placed on a second imaging area included in the given region, such imaging being done from inside the drum; and (5) an analyzing unit for analyzing existence/nonexistence of any foreign matter mingling with the inspection objects, such analysis being done on the basis of images captured by the first image capturing unit and the second image capturing unit.

### TECHNICAL FIELD

The present invention relates to equipment for detecting foreign matter that mingles in inspection objects.

### BACKGROUND ART

Known techniques for detecting foreign matter that mingles in inspection objects (e.g., food or medicine) include an inspection using visible light, an inspection using a metal detector, an inspection using a magnetic sensor, and an inspection using X-rays. However, these inspection techniques are limited to detection of specific foreign matter only: for example, an inspection technique that can detect metal cannot detect hair.

More specifically, in an inspection using visible light, it is impossible to obtain a contrast with foreign matter having a similar color and consequently it is difficult to achieve detection of foreign matter. With an inspection technique using a metal detector, the detection of nonmetallic matter is impossible, even if metallic foreign matter can easily be detected. In the case of using a magnetic sensor, foreign matter must be a magnetic substance, since the magnetic sensor cannot detect non-magnetic substance. The inspection technique using X-rays is advantageous when an inspection is performed from outside a wrapping, but it poses a problem of applying radiation to food or it is unsuitable for detection of foreign matter, such as hair, that is transparent to X-ray.

In Japanese Patent Application Publication Nos. H10-272427 and H11-190697, equipment for detection and removal of foreign matter which mingles with inspection objects is disclosed. However, with such equipment for inspection of foreign matter, it is only possible to detect and remove foreign matter adhering to the obverse of an inspection object, and it is impossible to remove foreign matter adhering to the reverse of the inspection object. For example, with a detection apparatus using visible light, detection using image analysis or the like and separation using an apparatus for removal is necessary to delete foreign matter, but such removal of foreign matter is possible only in the case where the foreign matter is adhering to a top surface of the inspection object or the top surface portion of the inspection object becomes a discolored foreign matter.

Therefore, with such known equipment, the detection and removal of foreign matter included in inspection objects cannot be sufficiently achieved. Particularly, when an inspection object is not small like fluid powder but comparatively large like a dry fruit, the detection and removal of foreign matter mingling in such inspection objects tend to become insufficient.

### PRIOR ART DOCUMENT

### Patent Document

Patent document 1 Japanese Patent Application Publication No. H10-272427
Patent document 2 Japanese Patent Application Publication No. H11-190697

### SUMMARY OF THE INVENTION

### Problems to be Solved by the Invention

The object of the present invention is to provide equipment for more sufficiently detecting foreign matter included in inspection objects.

### Means for Solving the Problem to be Solved

To achieve the object, provided is a foreign matter inspection apparatus comprising: (1) a transparent drum having a cylindrical shape turning around a horizontal central axis; (2) an object supplying unit for supplying inspection objects to such a given region on the surface of the drum as will not cause inspection objects to slide; (3) a first image capturing unit for imaging an inspection object placed on a first imaging area included in the given region, such imaging being done from outside the drum; (4) a second image capturing unit for imaging an inspection object placed on a second imaging area included in the given region, such imaging being done from inside the drum; and (5) an analyzing unit for analyzing existence/nonexistence of any foreign matter mingling with the inspection objects, such analysis being done on the basis of images captured by the first image capturing unit and the second image capturing unit.

### BRIEF DESCRIPTION OF THE DRAWINGS

FIG. 1 is a conceptional schematic diagram showing a foreign matter inspection apparatus relating to an embodiment of the present invention.

FIGS. 2A and 2B are partial enlarged views of the foreign matter inspection apparatus of FIG. 1: FIG. 2A shows the installation range of each image capturing unit; and FIG. 2B shows an installation example of each image capturing unit.

FIG. 3 is a side view of one embodiment of the foreign matter inspection apparatus of FIG. 1, in which a pressure air nozzle is provided as a means for separation.

FIG. 4 is a perspective view of the foreign matter inspection apparatus of FIG. 3.

FIG. 5 is a perspective view of a modified example of the foreign matter inspection apparatus of FIG. 3.

FIG. 6 is a side view showing an embodiment of the foreign matter inspection apparatus of FIG. 1, in which a sliding plate for removing foreign matter is provided as a separation means.

FIG. 7A shows a perspective view of the foreign matter inspection apparatus of FIG. 6 at a time of allowing passage of conforming product; FIG. 7B shows a perspective view likewise at a time of allowing passage of foreign matter.

FIG. 8 is a side view showing another embodiment of the foreign matter inspection apparatus of FIG. 1, in which a sliding plate for removing foreign matter is provided as a separation means.

FIG. 9A shows a perspective view of the foreign matter inspection apparatus of FIG. 7 at a time of allowing passage of conforming product; FIG. 9B shows a perspective view likewise at a time of allowing passage of foreign matter.

FIG. 10 is a side view of one embodiment of the foreign matter inspection apparatus of FIG. 1, in which a revolution body and a partition board for removing foreign matter is provided as a means for separation.

FIG. 11 is a perspective view of the foreign matter inspection apparatus of FIG. 10.

### DETAILED DESCRIPTION OF THE INVENTION

Hereinafter, preferred embodiments of the present invention will be described in reference to the accompanying drawings. The drawings are provided for the purpose of explaining the embodiments and are not intended to limit the scope of the invention. In the drawings, an identical mark represents the same element so that the repetition of explanation may be omitted. The dimensional ratios in the drawings are not always exact.

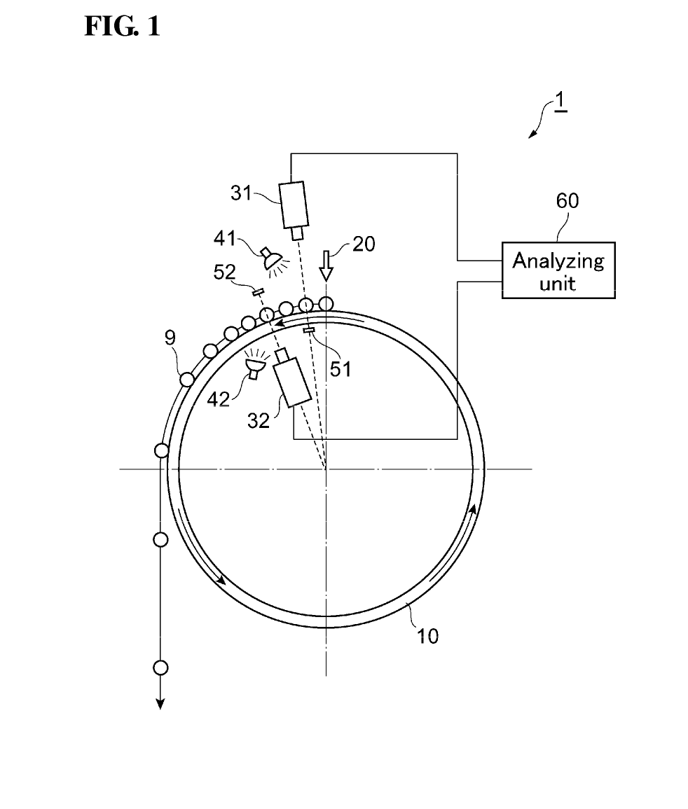

FIG. 1 is a conceptional schematic diagram showing a foreign matter inspection apparatus relating to an embodiment of the present invention. The foreign matter inspection apparatus 1, which is equipment for detecting foreign matter mingling with inspection objects 9, comprises a drum 10, an object supplying unit 20, a first image capturing unit 31, a second image capturing unit 32, and an analyzing unit 60. In FIG. 1, the components other than the analyzing unit 60 are shown as a side view seen in the extending direction of the central axis of the drum 10 having a cylindrical shape.

The drum 10, which has a cylindrical shape and turns around the horizontal central axis, is made of a transparent material (e.g., silica glass). The material of the drum 10 must be transparent to such a degree as the second image capturing unit 32 and a second illuminating unit 42 which are provided inside the drum 10 can achieve observation of inspection objects through the drum 10. The object supplying unit 20 supplies inspection objects 9 onto a given region that does not cause the inspection objects 9 to slide on the surface of the drum 10.

The first image capturing unit 31 is provided outside the drum 10, and from outside the drum 10 images the inspection objects 9 that lie at the first imaging area included in the given region that does not cause the inspection objects 9 to slide on the surface of the drum 10. For the purpose of imaging by the first image capturing unit 31, preferably the first illuminating unit 41 is provided outside the drum 10 and the first absorbing board 51 is preferably provided inside the drum 10. The first illuminating unit 41 illuminates the inspection objects 9, and the first image capturing unit 31 images by receiving light scattered from the inspection objects 9 upon such illumination. The first absorbing board 51, which functions as a background in the case of imaging by the first image capturing unit 31, has the absorption surface arranged to face the first image capturing unit 31. Preferably, the optical axis of the first image capturing unit 31 is arranged perpendicular to the central axis of the drum 10, and the absorption surface of the first absorbing board 51 is preferably arranged so as to intersect the optical axis of the first image capturing unit 31 at right angles.

The second image capturing unit 32 is provided inside the drum 10, and from inside the drum 10 images inspection objects 9 lying at the second imaging area included in the given region that does not cause the inspection objects 9 to slide on the surface of the drum 10. For the purpose of imaging by the second image capturing unit 32, preferably the second illuminating unit 42 is provided inside the drum 10, and the second absorbing board 52 is preferably provided outside the drum 10. The second illuminating unit 42 illuminates the inspection objects 9 through the drum 10, and the second image capturing unit 32 images by receiving light scattered from the inspection objects 9 upon such illumination. The second absorbing board 52, which functions as a background in the case of imaging by the second image capturing unit 32, has the absorption surface arranged to face the second image capturing unit 32. Preferably, the optical axis of the second image capturing unit 32 is arranged perpendicular to the central axis of the drum 10, and the absorption surface of the second absorbing board 52 is preferably arranged so as to intersect the optical axis of the second image capturing unit 32 at right angles.

The analyzing unit 60 analyzes existence/nonexistence of foreign matter in the inspection objects 9 on the basis of images captured by each of the first image capturing unit 31 and the second image capturing unit 32.

In the foreign matter inspection apparatus 1, preferably the first imaging area and the second imaging area are linear ones that are parallel to the central axis of the drum 10. Preferably, the drum 10 is made of glass, and the first image capturing unit 31 and the second image capturing unit 32 perform imaging by receiving near-infrared light. Also, it is preferable that the first image capturing unit 31 and the second image capturing unit 32 can respectively obtain spectrum of the near-infrared light. The first image capturing unit 31 and the second image capturing unit 32 can be composed of a two-dimensional photodetector and a spectrometer (e.g., prism and diffraction grating) for splitting near-infrared light. In such case, a specific direction in the light-receiving face of the two-dimensional photodetector corresponds to an imaging position, and the direction intersecting such specific direction at right angles corresponds to the wavelength of the light.

The first image capturing unit 31 and the second image capturing unit 32 respectively acquire spectrum of near-infrared light, allowing discrimination of foreign matter mingling in inspection objects 9 even if it is foreign matter that cannot be discriminated by means of visible light. Therefore, foreign matter detection ability can be improved. Also, by imaging inspection objects 9 from both inside and outside of the drum 10 so that foreign matter of the inspection objects 9 can be detected, it is made possible to perform the detection of foreign matter more sufficiently.

Also, since inspection objects 9 are imaged and detected at the first imaging area and the second imaging area both of which do not cause the inspection objects 9 to slide, more sufficient time can be secured for imaging and analysis as compared with the case where the inspection objects 9 are imaged while freely falling. Thus, a slow-response unit using near-infrared light can be adopted as the first image capturing unit 31 and the second image capturing unit 32.

For supplying inspection objects 9 to the given region where the inspection objects 9 do not slip on the surface of the drum 10 and for imaging the inspection objects 9 in the region, preferably the outside diameter of the drum 10 is 100 mm or more and the thickness of the drum 10 is 20 mm or less. Thus, the first imaging area and the second imaging area can be secured in the above-mentioned given region, and also a sufficient space for arranging both the second image capturing unit 32 and the second illuminating unit 42 can be secure inside the drum 10.

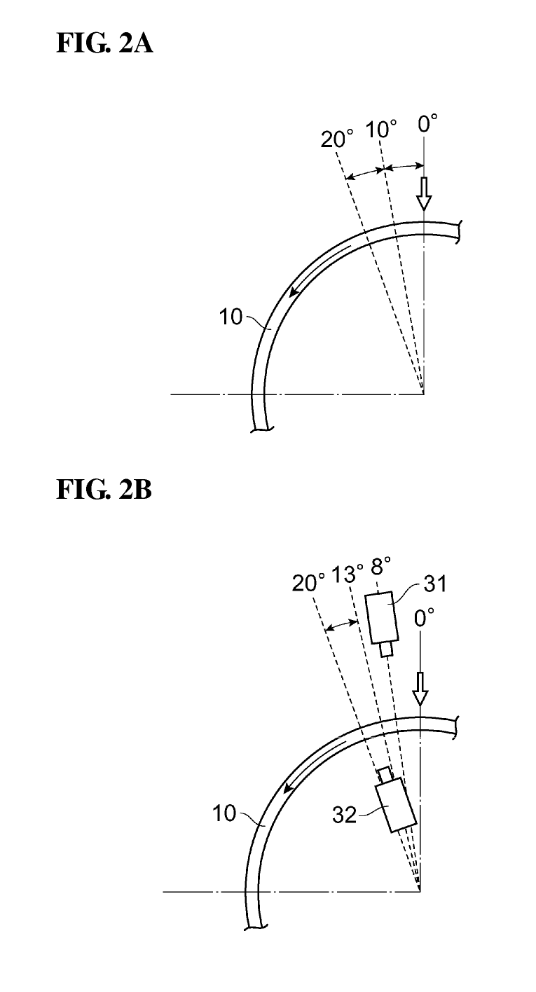

FIGS. 2A and 2B are partial enlarged views of the foreign matter inspection apparatus: FIG. 2A shows the installation range of the first image capturing unit 31 and the second image capturing unit 32; and FIG. 2B shows an example of their installation. To image inspection objects 9 from outside the drum 10 with the first image capturing unit 31 and to image the inspection objects 9 from inside the drum 10 with the second image capturing unit 32, it is preferable that as shown in FIG. 2A, the object supplying unit 20 supply the inspection objects to a top part of the drum 10, and the first image capturing unit 31 perform imaging in a direction that falls at an angle within the range of 0° to 10° relative to a vertical plane including the central axis of the drum 10, whereas the second image capturing unit 32 perform imaging in a direction that falls at an angle within the range of 10° to 20° relative to the vertical plane including the central axis of the drum 10, while the imaging-directions of the first image capturing unit 31 and the second image capturing unit 32 form an angle of 5° or more relative to each other. By doing so, mutual interference can be avoided at the time of imaging by the first image capturing unit 31 and the second image capturing unit 32. As shown in FIG. 2B, for example, when the imaging-direction of the first image capturing unit 31 is 8°, the imaging-direction of the second image capturing unit 32 is preferably in the range of 13° to 20°.

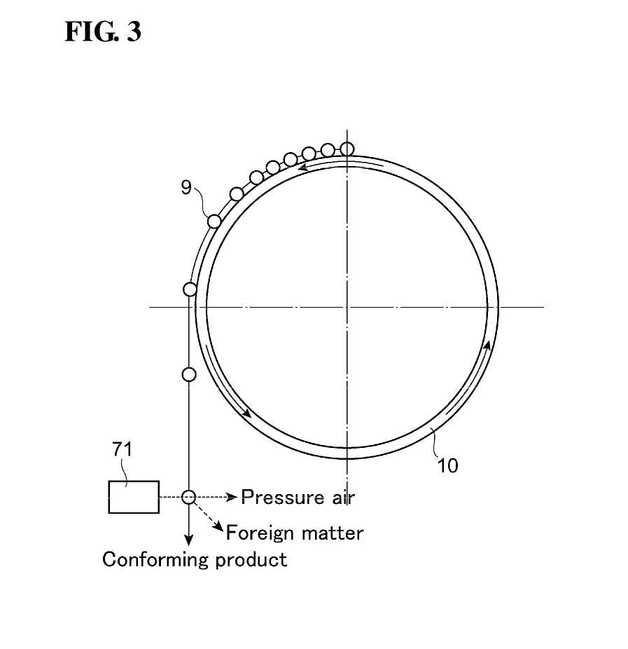

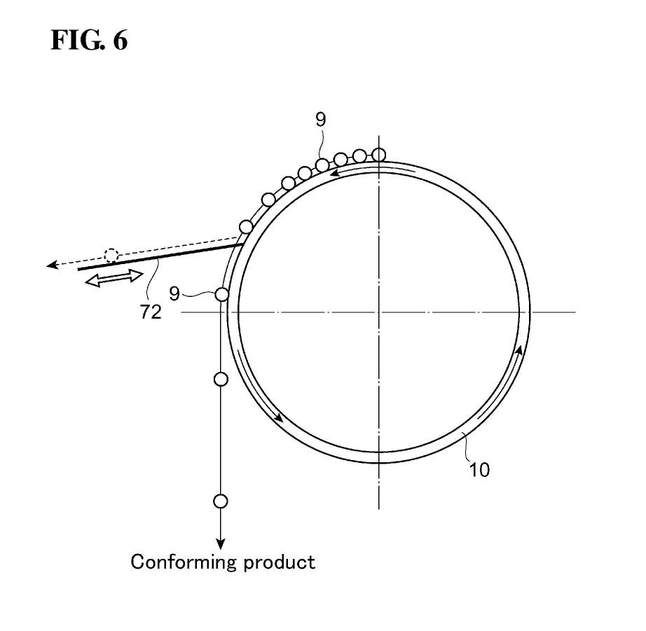

The foreign matter inspection apparatus 1 preferably further comprises a separation means for separating, on the basis of analysis made by the analyzing unit 60, the inspection objects 9 into a part including no foreign matter and a part including foreign matter. The part which includes foreign matter may be any of the cases in which the part is foreign matter itself or the part consists of foreign matter and conforming product around the foreign matter. The separation by the separation means may be done when inspection objects are falling from the drum 10 as shown in FIG. 3 to FIG. 5, or when inspection objects are lying on the surface of the drum 10 as shown in FIG. 6 to FIG. 11.

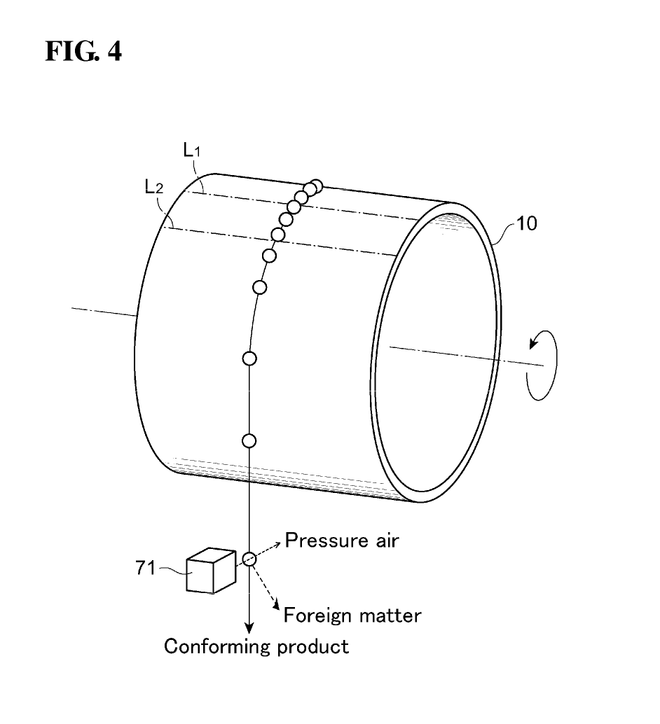

FIGS. 3 and 4 show embodiments in which a pressure air nozzle 71 is provided as a separation means of the foreign matter inspection apparatus 1: FIG. 3 is a side view and FIG. 4 is a perspective view. The pressure air nozzle 71 performs separation by jetting pressure air so as to selectively exclude foreign matter when inspection objects fall from the drum 10. In such case, the pressure air jetting by the pressure air nozzle 71 is done according to instructions from the analyzing unit 60, and the timing of such jetting is determined in consideration of various delay time. FIG. 4 shows the first imaging area L₁ and the second imaging area L₂, each of which has a linear form.

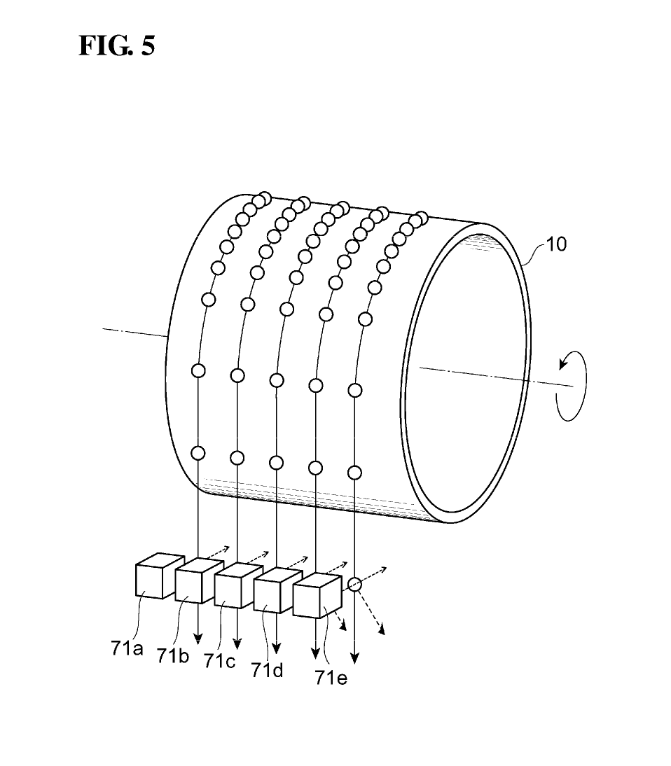

FIG. 5 is a perspective view showing a modified example of the foreign matter inspection apparatus 1 in which pressure air nozzles 71 are provided as the separation means. It is preferable that when the supply of inspection objects 9 is performed at a plurality of positions located on a line at a top part of the drum 10, a plurality of pressure air nozzles 71a to 71e be provided corresponding to the plurality of supply positions.

As for the separation means that is used for separation when inspection objects are falling from the drum 10, various means are possible in addition to the above-mentioned pressure air nozzle 71: such separation may be done by sucking foreign matter, or by mechanically changing the falling course of foreign matter.

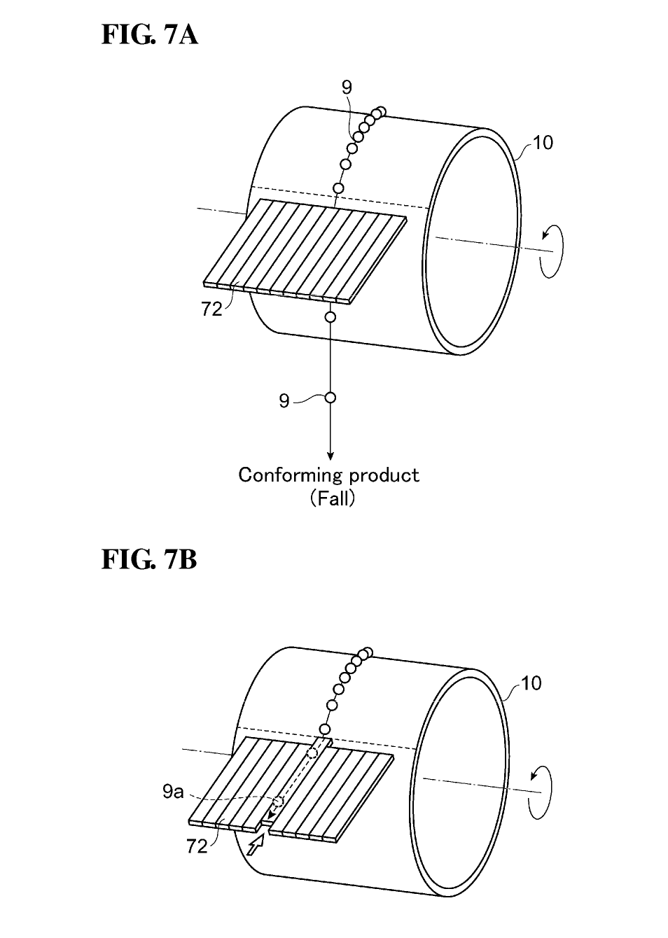

FIGS. 6, 7A, and 7B show an embodiment of foreign matter inspection apparatus 1 in which a sliding plate 72 for removing foreign matter is used as the separation means. FIG. 6 is a side view, and FIG. 7A is a perspective view showing a state of passage of conforming product (part which does not include foreign matter) and FIG. 7B is a perspective view showing a state of passage of foreign matter. When the supply of inspection objects 9 is performed at a plurality of positions located along a line on a top part of the drum 10, the sliding plate 72 includes a plurality of slide boards corresponding to the plurality of supply positions.

When the analyzing unit 60 judges that no foreign matter is included, the tip of the sliding plate 72 for removing foreign matter is made apart from the surface of the drum 10 as shown in FIG. 7A, allowing the conforming product of the inspection objects 9 to fall freely from the drum 10. On the other hand, when the analyzing unit 60 determines that foreign matter is included, the tip of the sliding plate 72 touches the surface of the drum 10 as shown in FIG. 7B, so that a part 9a including foreign matter is led to pass on the top surface of the sliding plate 72. Thus, the sliding plate 72 performs separation by selectively changing the course of a part including foreign matter of the inspection object 9 when the inspection object lies in the given region.

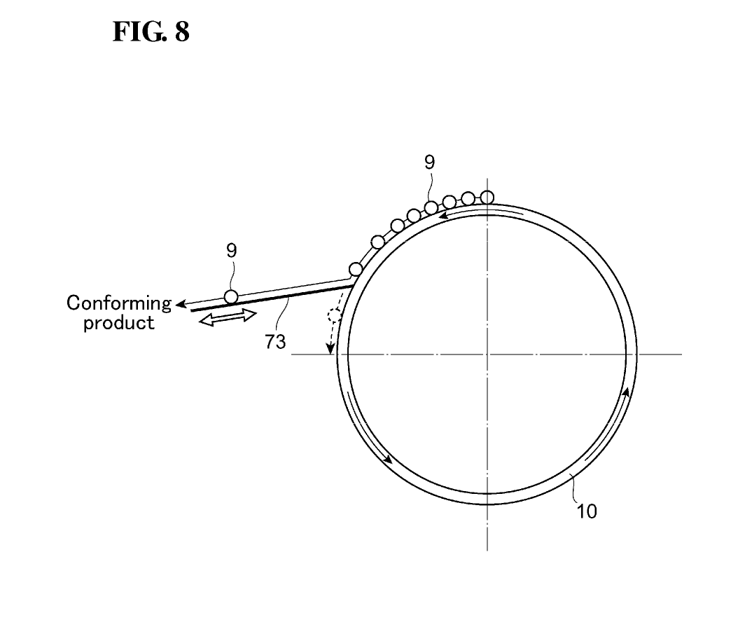

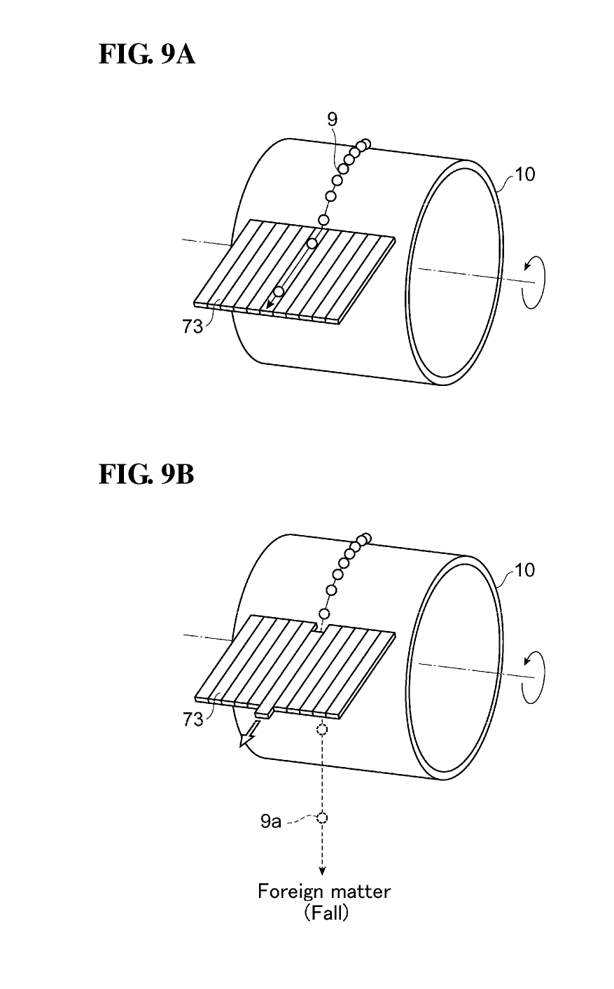

FIGS. 8, 9A and 9B show an embodiment of the foreign matter inspection apparatus 1 in which a sliding plate 73 for removing foreign matter is provided as the separation means. FIG. 8 is a side view, and FIG. 9A is a perspective view showing a state of passage of conforming product (part which does not include foreign matter), whereas FIG. 9B is a perspective view showing a state of passage of foreign matter. When the supply of inspection objects 9 is performed at a plurality of positions located along a line on a top part of the drum 10, the sliding plate 73 includes a plurality of slide boards corresponding to the plurality of supply positions.

When the analyzing unit 60 judges that no foreign matter is included, the tip of the sliding plate 73 touches the surface of the drum 10 as shown in FIG. 9A, thereby leading conforming product of the inspection objects 9 to pass on the top surface of the sliding plate 73. On the other hand, when the analyzing unit 60 determines that foreign matter is included, the tip of the sliding plate 73 is made apart from the surface of the drum 10 as shown in FIG. 9B, allowing a part 9a including foreign matter to fall freely from the drum 10. Thus, of inspection objects 9, the sliding plate 73 performs separation by setting the course of a part including no foreign matter so as to be apart from the surface of the drum 10, while setting the course of a part including foreign matter to allow vertical falling.

It is preferable that when the sliding plates 72 and 73 for removing foreign matter have such a structure as shown in FIGS. 6 to 9, the tips of the sliding plates have a frictional coefficient that is smaller than the surface of the drum 10 since they touch the surface of the drum 10.

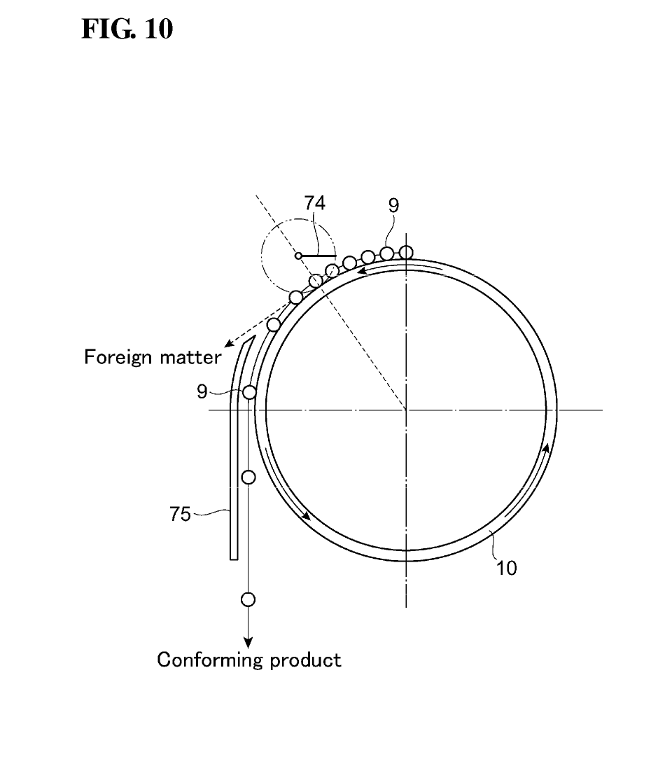

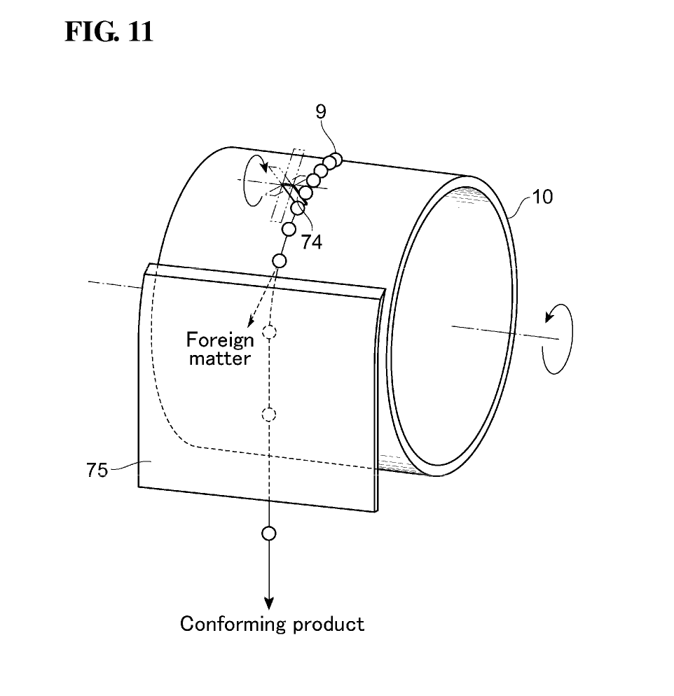

FIGS. 10 and 11 show an embodiment of the foreign matter inspection apparatus 1, in which a revolution body 74 for removing and a partition board 75 are provided as the separation means: FIG. 10 is a side view and FIG. 11 is a perspective view. When the supply of inspection objects 9 is performed at a plurality of positions located along a line on a top part of the drum 10, a plurality of revolution bodies 74 for removing may be provided corresponding to the plurality of supply positions, or a single revolution body 74 for removing may be provided in such a structure as enables removal of foreign matter by moving in a direction along the central axis of the drum 10 (The revolution body 74 as used hereinafter means either of the above-mentioned cases).

When the analyzing unit 60 judges that no foreign matter is included, the revolution body 74 allows inspection objects 9 on the surface of the drum 10 to pass just as they are, and further lets the inspection objects 9 to pass through the interval between the drum 10 and the partition board 75 so that the inspection objects 9 fall freely from the drum 10. On the other hand, when the analyzing unit 60 determines that foreign matter is included, the foreign matter lying on the surface of the drum 10 is flicked by the revolution body 74 in the tangent direction so that the foreign matter is swept away to the outside of the partition board 75. Thus, the revolution body 74 performs separation of inspection objects 9 by selectively removing, from the top surface of the drum 10, a part which includes foreign matter when the inspection objects 9 lie in a given region thereon. Even if the foreign matter is adhering to the surface of the drum 10, the removal of the foreign matter can surely be achieved since the revolution body 74 sweeps the foreign matter away from the surface of the drum 10.

Preferably, the tip of the revolution body 74 is made of a material that is softer than the surface of the drum 10 since the tip of the revolution body 74 touches the surface of the drum 10. Also, it is preferable that the tip of revolution body 74 touch the surface of the drum 10 over a circumferential length of 1 cm or more of the drum 10. Also, preferably the tip of the revolution body 74 has a shape like a whisk.

### INDUSTRIAL APPLICABILITY

The foreign matter inspection apparatus of the invention can be used as equipment for inspecting raw materials or products of food and medicine, and detecting and removing foreign matter.

1. A foreign matter inspection apparatus comprising:
a transparent drum having a cylindrical shape turning around a horizontal central axis;
an object supplying unit for supplying inspection objects to a given region on the surface of the drum, the given region not causing the inspection objects to slide;
a first image capturing unit for imaging the inspection objects placed on a first imaging area included in the given region, such imaging being done from outside the drum;
a second image capturing unit for imaging the inspection objects placed on a second imaging area included in the given region, such imaging being done from inside the drum;
an analyzing unit for analyzing existence/nonexistence of any foreign matter mingling with the inspection objects, such analysis being done on the basis of images captured by the first image capturing unit and the second image capturing unit.

2. A foreign matter inspection apparatus according to claim 1, wherein the first imaging area and the second imaging area are linear and parallel to the central axis of the drum.

3. A foreign matter inspection apparatus according to claim 1,
wherein the drum is made of glass, and the first image capturing unit and the second image capturing unit perform imaging by receiving near-infrared light.

4. A foreign matter inspection apparatus according to claim 1,
wherein the outside diameter of the drum is 100 mm or more and the thickness of the drum is 20 mm or less.

5. A foreign matter inspection apparatus according to claim 1, wherein
the object supplying unit supplies the inspection objects to a top part of the drum, and the first image capturing unit performs imaging in a direction having an angle within the range of 0° to 10° relative to a vertical plane including the central axis of the drum,
the second image capturing unit perform imaging in a direction having an angle within the range of 10° to 20° relative to the vertical plane including the central axis of the drum, and
the imaging-directions of the first image capturing unit and the second image capturing unit form an angle of 5° or more relative to each other.

6. A foreign matter inspection apparatus according to claim 1, further comprising a separation means for separating, on the basis of analysis made by the analyzing unit, the inspection objects into a part including no foreign matter and a part including foreign matter, such separation being done when the inspection objects are falling from the drum.

7. A foreign matter inspection apparatus according to claim 1, further comprising a separation means for separating, on the basis of analysis made by the analyzing unit, the inspection objects into a part including no foreign matter and a part including foreign matter, such separation being done when the inspection objects are lying on the surface of the drum.

8. A foreign matter inspection apparatus according to claim 7,
wherein the separation means selectively changes the course of a part including foreign matter of the inspection objects when the inspection objects, lie in the given region.

9. A foreign matter inspection apparatus according to claim 7,
wherein of the inspection objects, the separation means sets the course of a part including no foreign matter so as to be apart from the surface of the drum, while setting the course of a part including foreign matter to allow vertical falling.

10. A foreign matter inspection apparatus according to claim 7,
wherein of the inspection objects, the separation means selectively removes a part including foreign matter from the top surface of the drum when the inspection objects lie in the given region.
